(19) United States
(12) Patent Application Publication
(10) Pub. No.: US 2003/0002744 A1
(43) Pub. Date: Jan. 2, 2003

(54) Method for producing an image noise table having statistics for use by image processing algorithms

(75) Inventors: Alex A. Lopez-Estrada, Chandler, AZ (US); Peter D. Burns, Fairport, NY (US)

Correspondence Address: Thomas H. Closel, Legal Staff, Eastman Kodak Company, 343 State Street, Rochester, NY, 14650-2201, US

(73) Assignee: Eastman Kodak Company

(21) Appl. No.: 09/827,552

(22) Filed: Apr. 6, 2001

(51) Int. Cl. G06K 9/40; G06T 5/00

(52) U.S. Cl. 382/254; 382/275

(57) ABSTRACT

A method for producing an image noise table having statistics in a particular metric format for use with image processing algorithms including gathering estimated noise statistics of noise estimates provided from image capture medium, or image capture device(s), or combinations thereof which are in one or more metric formats; transforming the gathered noise statistics from their metric format(s) to a second metric format useable in the image noise table; transforming the second metric format noise statistics based upon the spatial qualities of image capture to a format for use in the image noise table; and providing the image noise table using the transformed second metric format statistics.

### CROSS-REFERENCE TO RELATED APPLICATION(S)

Reference is made to commonly assigned copending application Ser. No. 09/337,792 filed Jun. 22, 1999 entitled “Method for Modification of Non-Image Data in an Image Processing Chain” by Peter D. Burns et al., the disclosure of which is incorporated herein by reference.

### FIELD OF THE INVENTION

The present invention relates generally to the field of image processing, and, more particularly, to effectively producing an image noise table that is particularly suitable for use with image processing algorithms.

### BACKGROUND OF THE INVENTION

Many image processing algorithms benefit from or require an estimate of the relative signal and noise components in the image data. For example, adaptive sharpening uses the noise estimate to discern noise from texture and image (signal) information, avoiding sharpening of noise in uniform areas, where it is more visible. The noise estimate can be drawn from a table of root-means-square (RMS) noise statistics stored in an array corresponding to the standard deviations for the pixel values in nominally uniform image areas. These statistics can be stored for all neutral image signal levels. This array of RMS values is the noise table or grain table. A distinction is often made between grain tables and noise tables. A grain table contains noise statistics associated with photographic film grain noise, and a noise table incorporates statistics associated with all components of an imaging system, such as film, scanner, signal encoding and other image processing steps.

Supplying an accurate image noise table is important for the optimal and efficient operation of a digital imaging system that includes noise-sensitive image processing operations, such as noise reduction or sharpening. FIG. 1 is a diagram showing the general sequence of operations involved in acquiring a digital image (Block 4) from an image medium (Block 1) using an image capture device (Block 2). The image processing system (Block 6) includes an operation that is image noise-sensitive and requires information regarding the image noise statistics for digital images from image the capture device and medium. These statistics are supplied by Block 10. These statistics may be in the form of an image noise table. The image processing system produces the processed digital image, Block 8.

In general, the noise characteristics of a digital image are dependent on several factors; image capture medium and image capture device (scanner or camera), scene/document exposure level, etc. Experimental determination of the noise levels for each image or set of similar images, however, is often impractical, since it can involve specialized calibration and acquisition of test scenes. This is particularly true of digital photofinishing systems that must accommodate several film, camera and exposure variables without access to, e.g., film stock or the camera used.

Film granularity (RMS noise) measurements are obtained as standard practice in the photographic film manufacturing process, and these measurements are available for most films. The measurements are often produced using a microdensitometer with a specific scanning aperture, usually a circular aperture of 48 μm diameter. One problem with using these data as direct measures of image noise in a scanned film image is that the manner and instrument used influence the measurements. Since the illumination, optics and detector used in manufacturing differ from those of the photofinishing scanner, the film granularity data from the manufacturer do not characterize noise of the scanned film.

The way in which the detected signal, e.g., film transmittance, is processed prior to the computation of the statistics determines the metric. For example, an image capture device can record and store the image as optical density metric, and noise statistics such as root-means-square (RMS) density. Alternatively, the same device could be used to record and store the digital image as scene exposure or optical transmittance metric. Each of these options would result in a different noise table.

Image noise statistics are also influenced by the image sampling characteristics of the image capture device. As a simple example, consider two digital scanners, with different scanning resolutions and therefore scanning regions (the area scanned for each image pixel). For uniform image areas dominated by stochastic (grain-type) noise, the recorded fluctuations will generally be a function of aperture area. Specifically, if the fluctuations are spatially uncorrelated, the RMS values will be proportional to the square root of the aperture area (J. C. Dainty and R. Shaw, Image Science, Academic Press, 1974, pages 58, 219-220).

Practical noise transformation due to different spatial sampling properties may need to include two system properties; image noise spatial correlation, and scanner optics and detector spatial sampling, as described by the MTF. In the following discussion, it is assumed that the image metric for both scanners is identical, so the only image noise transformation required is that due to the different spatial sampling.

As a consequence of Parseval's Theorem, the noise variance from any nominally uniform image area can be computed from the noise power spectrum, as

σ²=∫∫NPS(u,v)·du·dv (1)

where u and v are the spatial frequency coordinates in the x and y direction, respectively. If the NPS is computed from sampled image data, the variance of Equation (1) is the variance per sample, or variance per pixel. For an image captured by scanning an imaging medium, here taken to be photographic film, the digitized image noise power spectrum will be influenced by the image sampling characteristics of the scanner, as described by the MTF, of the image capture device (Block 2), here designated as scanner 1. The expected noise variance, therefore, will be equal to the integral (as in Eq. (1)) of a modified noise power spectrum. For a circularly symmetrical scanning MTF,

σ²_{scanner 1}=2π∫NPS_{film}(ω)·MTF²_{scanner1}(ω)·dω (2)

Here we consider the image noise due to the image medium and ignore image noise introduced by the scanner itself. In a similar fashion, there are also noise statistics for images captured with a second image capture device (Block 12), which will be designated as scanner 2. Taking the ratios of the variances of the observed noise statistics, the following relationship follows from Equation (2),

$$\frac{{σ}_{scanner1}^{2}}{{σ}_{scanner2}^{2}} = \frac{\int {NPS}_{film} ( ω ) \cdot {MTF}_{scanner1}^{2} ( ω ) \cdot ω \cdot ⅆ ω}{\int {NPS}_{film} ( ω ) \cdot {MTF}_{scanner2}^{2} ( ω ) \cdot ω \cdot ⅆ ω} \qquad ( 3 )$$

Equation (3) is the general expression for comparing image noise variance as provided by different image capture devices.

Image noise measurements reported by a manufacturer for any particular imaging medium are usually taken by using a microdensitometer of scanning aperture radius r. Here, a microdensitometer can be thought of as a special image capture device, having an image sampling MTF corresponding to that of a scanning aperture, with little influence of the scanner optics. In this case, if scanner 1 (the image capture device of Block 2) is a microdensitometer (Dainty and Shaw, pg. 280) the MTF of the scanner 1 is

$${MTF}_{scanner1} ( ω ) = \frac{2 {J}_{1} ( 2 πω r )}{2 πω r} \qquad ( 4 )$$

where J₁ is the first order Bessel function. Equation (3) could then be rewritten so that scanner 1 is the microdensitometer and scanner 2 is the second image capture device for which the noise table is desired. Thus Equation (3) becomes,

$$\frac{{σ}_{scanner2}^{2}}{{σ}_{scanner1}^{2}} = \frac{\int {NPS}_{film} ( ω ) \cdot {MTF}_{scanner2}^{2} ( ω ) \cdot ω \cdot ⅆ ω}{\int {NPS}_{film} ( ω ) \cdot {( \frac{2 {J}_{1} ( 2 πω r )}{2 πω r} )}^{2} \cdot ω \cdot ⅆ ω}$$

$$or ,$$

$${σ}_{scanner2}^{2} = {σ}_{scanner1}^{2} π {A}_{scanner1} \frac{\int {NPS}_{film} ( ω ) \cdot {MTF}_{scanner2}^{2} ( ω ) \cdot ω \cdot ⅆ ω}{\int {NPS}_{film} ( ω ) \cdot \frac{{J}_{1}^{2} ( 2 πω r )}{ω} \cdot ⅆ ω} \qquad ( 5 )$$

where A_{scanner1} is the microdensitometer aperture area, π·r². Equations (3) and (5) indicate that in order to transform the image noise statistics (variance) as provided by scanner 1 (the image capture device of Block 2) to those that would be provided by a second scanner 2 (the second image capture device of Block 12), requires information about the imaging medium noise-power spectrum and the scanner spatial sampling characteristics (MTF).

Cok and Gray in U.S. Pat. No. 5,641,596 set forth a method for producing an image noise table by scanning a target of various density patches, and measuring the noise statistics as a function of the density of each patch. This method works well as long as the target is available for each film type and scanned on the scanner of interest. In U.S. Pat. No. 5,923,775 of Synder et al. a method for estimating the noise statistics from the digitized image is described. This method eliminates the variability in the film grain and scanner noise measurements. However, this method relies on the accuracy of the edge detection technique used to identify uniform regions in the image and on the assumption that a particular image will have enough uniform areas of various densities to cover the image signal range needed for the noise table.

Since image noise tables are a function of image capture medium and image capture device, producing reliable image noise tables directly in the manner of Cok and Gray requires producing targets in each film type of interest and scanning in every scanner of interest. For photographic film the main noise contributor is film granularity, and it varies as a function of image exposure. Digital image capture devices such as digital cameras and scanners also contribute image noise. In order to have a robust process for producing the image noise tables, it is desired to include variability in film processing and manufacturing and between various image capture devices. This, in turn, results in a time consuming and labor-intensive process. Also, some applications do not have the flexibility of producing film targets that they can scan and measure, e.g., Digital Motion Picture.

### SUMMARY OF THE INVENTION

It is an object of the present invention to provide a method which can readily gather information concerning image capture medium, or image capture device(s), or combinations thereof and spatial qualities of image capture to provide an effective image noise table for use in image processing.

Another object of the present invention is to transform image noise statistics captured from one or more image capture devices, and account for both the metric and spatial sampling so as to produce transformed noise statistics, as indicated in FIG. 2.

These objects are achieved by a method for producing an image noise table having statistics in a particular metric format for use with image processing algorithms, comprising the steps of:

a) gathering estimated noise statistics of image noise provided from image capture medium, or image capture device(s), or combinations thereof which are in one or more metric formats;

b) transforming the gathered noise statistics from their metric format(s) to a second metric format useable in the image noise table;

c) transforming the second metric format noise statistics based upon the spatial qualities of image capture to a format for use in the image noise table; and

d) providing the image noise table using the transformed second metric format statistics.

The present invention is particularly suitable for use with many image processing algorithms. These algorithms benefit from or require an estimate of the relative signal and noise components in the image data, as indicated in FIG. 1. The noise characteristics of a digital image are dependent on several factors such as, input medium and image capture device (scanner or camera), scene/document exposure level.

An important aspect of this invention is that it provides a method which can transform the manufacturing granularity data or other reference image noise statistics into image noise tables, which include both the medium and a second image capture device contributions. The present invention can solve the problem of producing the image noise tables to use in digital image processing of a digital image. The method can take as input, film granularity measurements from processing/manufacturing surveys and existing noise tables for print or document scanners. The method produces output accurate image noise tables for a given different scanner or camera.

A feature of the invention is producing the image noise tables to use in image processing via an analytic model that can take in film granularity measurements from processing/manufacturing surveys or image noise tables for one image capture device, and output an accurate image noise table for a second image capture device. FIG. 2 shows an outline of the procedures.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is an overall block diagram that depicts the operations for the acquiring of a digital image from an image medium by an image capture device, and processing the digital image using one or more operations that are noise-sensitive;

FIG. 2 shows the present invention which uses metric transformations and spatial transformations to produce an image noise table for an image processing system such as shown in FIG. 1;

FIG. 3 is a graph of spatial frequency vs. MTF for a particular film scanner in two modes of operation;

FIG. 4 is a graph of a image density vs. standard deviation of image density for an input image noise table showing standard deviation for a particular photographic film, and the table after metric and spatial transformations;

FIG. 5 is a graph of green image density vs. standard deviation for an image capture device, which is a particular scanner; and

FIG. 6 is a graph of green image density vs. standard deviation for an image noise table directly from a scanner, and one transformed from corresponding microdensitometer data.

### DETAILED DESCRIPTION OF THE INVENTION

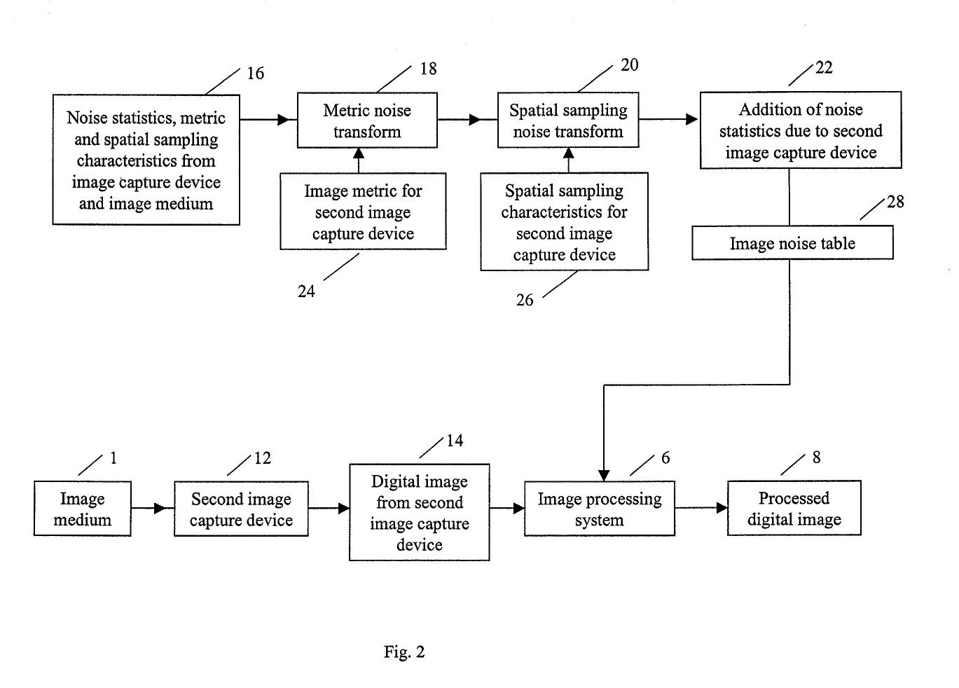

The development of this noise transformation and the use of its output in image processing algorithms are the foundation for the invention disclosed herein. The present invention produces image noise tables for use in an image processing system via three steps as is generally shown in FIG. 2, Blocks 18, 20 and 22.

It has been determined that for image noise statistics or noise tables to be useful in image processing systems, the statistical values must be accompanied by a specification of the image metric and spatial sampling conditions for which they apply. The image metric can be defined in terms of a colorimetric signal space. Any noise table, therefore, includes this information, unless it is specified, e.g., by other imaging system constraints or a standard image data format.

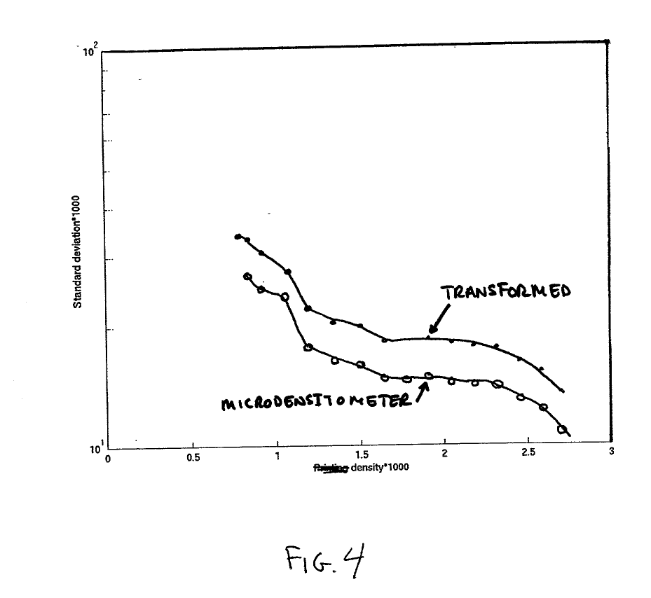

A noise table is computed from image noise statistics by interpolating between a limited set of mean signal and corresponding noise statistics, e.g. standard deviation or RMS values, so as to produce a table. In FIG. 4, the lines represent noise tables based on the plotted statistical values (the points). The noise table is a list of values that is used to characterize the image noise for any image signal value. This can be done by providing a table of RMS values for the range of possible neutral image signal values. It will be understood by those skilled in the art that a noise table does not have to be limited to only the neutral image signal values, and that in generating the table, data smoothing or fitting with a function (e.g., polynomial or spline function) can also be employed. In this last case, the noise table may be stored as an equation to be evaluated at various image signal levels, as needed by image processing operations.

Noise statistics of noise estimates concerning image capture media and image capture device(s) or combinations thereof are typically in one or more image metric and image sampling formats. In Block 16 these statistics are gathered, usually from nominally uniform image areas. Block 16 can supply the statistics as data values or in a noise table describing the image noise for images captured using an image capture device (Block 2). The pixel-to-pixel fluctuations are usually characterized by their standard deviation, or RMS values, but can also include spatial covariance or color covariance data. As will be understood by those skilled in the art, noise statistics from this image capture device can actually be a film granularity table that can be a list of root-mean-square (RMS) density fluctuation values for uniform image areas, and their corresponding average density values, together with the physical meaning of the data. The physical meaning is the data metric (film density, transmittance or other) and the effective sampling aperture used to acquire the data. For a multi-record imaging system, such as a three-record color system, the noise table contains data for each color-record (e.g., red, green and blue, or cyan, magenta and yellow).

After gathering these noise statistics for an image captured via an image capture device, blocks 18 and 20 operate on such noise statistics by applying two transformations. This is done in order to derive the corresponding image noise statistics, in the form of data values or noise table, pertaining to images acquired using a second image capture device (Block 2).

In block 18, the gathered image statistics are transformed using a metric transformation which transforms the gathered noise statistics from their metric format to a second metric format useable for images captured in the image metric of a second image capture device. The metric noise transform, Block 18, is derived from the image metric of the noise statistics from the image capture device of Block 2, supplied by Block 16, and the metric characteristics for images supplied by the second image capture device (Block 24). These two image metrics define the metric noise transform (Block 18) that is applied to the noise statistics from the image capture device to generate the transformed noise statistics to a second metric format useable in the image processing of images from the second image capture device. For examples of forms of transformations between image metrics, see the above referenced commonly assigned copending application Ser. No. 09/337,792 filed Jun. 22, 1999 entitled “Method for Modification of Non-Image Data in an Image Processing Chain” by Peter D. Bums et al., the disclosure of which is incorporated herein by reference.

In block 20, transformed noise statistics are transformed using a spatial sampling transformation which transforms the second metric format noise statistics from their second metric format (from Block 18) to a spatial sampling format useable for images captured in the spatial sampling format of the second image capture device. The spatial sampling transform, Block 20, is derived from the spatial sampling format of the image capture device, supplied by Block 16, and the spatial sampling format of the second image capture device (supplied by Block 26). These two image sampling formats define the spatial sampling transform (Block 20) that is applied to the transformed noise statistics from Block 18 to a second sampling format useable in the image processing of images from the second image capture device. The transformed noise statistics, presented in the form of a noise table (Block 28) are used by the image processing system (Block 6) to operate on digital images from the second image capture device (Block 14).

The spatial sampling format for the image capture device and the image medium, supplied by Block 16 can be in the form of an effective aperture area or MTF, and an image medium noise power spectrum (NPS) as shown in Equation (3). It will be understood that the point spread function of the image capture device and the autocovariance function of the image medium noise are inverse Fourier transforms of the MTF and NPS, respectively, and can therefore be supplied in their stead.

Block 20 of FIG. 2 provides a spatial sampling transform that is based on the general relationship described in Equation 5. Three practical embodiments will now be disclosed. In each case scanner 1 will refer to the image capture device of Block 2, and scanner 2 will refer to the second image capture device of Block 12.

Embodiment 1:

The spatial sampling transform of Block 20 can operate as in Equation (3) by scaling the transformed image noise statistics, from Block 18,

$${σ}_{scanner2} = {[ \frac{\int {NPS}_{film} ( ω ) \cdot {MTF}_{scanner2}^{2} ( ω ) \cdot ω \cdot ⅆ ω}{\int {NPS}_{film} ( ω ) \cdot {MTF}_{scanner1}^{2} ( ω ) \cdot ω \cdot ⅆ ω} ]}^{1 / 2} {σ}_{scanner1} \qquad ( 6 )$$

σ_{scanner2}=ασ_{scanner1}

where Block 16 supplies NPS_{film} and MTF_{scanner1}, and Block 26 supplies MTF_{scanner2}. Equation (6) supplies the spatial sampling transform of Block 20.

Embodiment 2:

The spatial sampling transform of Block 20 can also operate by deriving an effective circular sampling aperture for both image capture device and the second image capture device. In the case of spatially uncorrelated medium image noise, the NPS is flat over the spatial frequency range for which the aperture (or scanner MTF in that case) has significant response. In this case Block 16 supplies the MTF of image capture device and Block 26 supplies the MTF of the second image capture device. Here the medium NPS function is a constant, and therefore described by the value at any frequency, e.g., at zero frequency NPS(0). Taking the constant out of the integral in equation (4), and evaluating the integral:

$$\int \frac{{J}_{1}^{2} ( 2 πω r )}{ω} \cdot ⅆ ω = \frac{1}{2} ,$$

we obtain:

σ_{scanner2}=σ_{scanner1}[2πA_{scanner1}∫MTF²_{scanner2}(ω)·ω·dω]^{½} (7)

For a spatially uncorrelated medium NPS and ideal scanning apertures, it is known also that:

$${σ}_{scanner2} = {{σ}_{scanner1} [ \frac{{A}_{scanner1}}{{A}_{scanner2}} ]}^{1 / 2} \qquad ( 8 )$$

where A_{scanner1} and A_{scanner2} are the effective apertures areas of the each image capture device, respectively. Therefore the effective scanner aperture area is given by:

$${A}_{scanner} = \frac{1}{2 π \int {MTF}_{scanner}^{2} ( ω ) \cdot ω \cdot ⅆ ω} , \qquad ( 9 )$$

or expressed as a diameter:

$${d}_{scanner} = \sqrt{\frac{4 {A}_{scanner}}{π}} = \sqrt{\frac{2}{{π}^{2} \int {MTF}_{scanner}^{2} ( ω ) \cdot ω \cdot ⅆ ω}} \qquad ( 10 )$$

Equation (8) supplies the spatial sampling transform of Block 20.

Embodiment 3:

The spatial sampling transform of Block 20 can also operate using an effective circular sampling aperture for both the image capture device and second image capture device, by numerically obtaining the ideal circular aperture that will have approximately the same spatial scanning point spread function as each image capture device.

In this embodiment Block 26 again supplies the MTF (or point spread function) of the second image capture device. In Block 20, the following is done in order to derive an effective circular sampling aperture for the second image capture device.

1) Assume an initial aperture.

2) Compute the MTF of the selected circular aperture. The MTF could be approximated using a first order Bessel function following the equation:

MTF_{cir}(f)=1 for f=0 cycles/mm

$${MTF}_{cir} ( f ) = \vert \frac{2 \cdot {J}_{1} ( π \cdot d \cdot f )}{π \cdot d \cdot f} \vert for f > 0 cycles \text{/} mm$$

where f is the spatial frequency in cycles/mm, d is the circular aperture in mm.

3) Integrate the MTF curves for the circular aperture MTF_{cir} and the scanner's MTF (MTF_{scan}) up to the highest frequency of interest, to obtain the areas under the curves (A_{cir} and A_{scan} respectively). This could be accomplished by using any numerical integration technique such as the trapezoid rule.

4) Compare both areas:

If A_{cir}≈A_{scan}

Stop. You found the scanner's effective aperture diameter. d₂=d.

Else if A_{cir}>A_{scan}

Decrease d by a specified amount (˜0.05 μm)

Else,

Increase d by a specified amount (˜0.05 μm).

5) Go to step 2.

The resulting computed diameter, d, is used to compute an area of a circle of the same diameter, and then Equation (8) is used as the spatial sampling transform of Block 20.

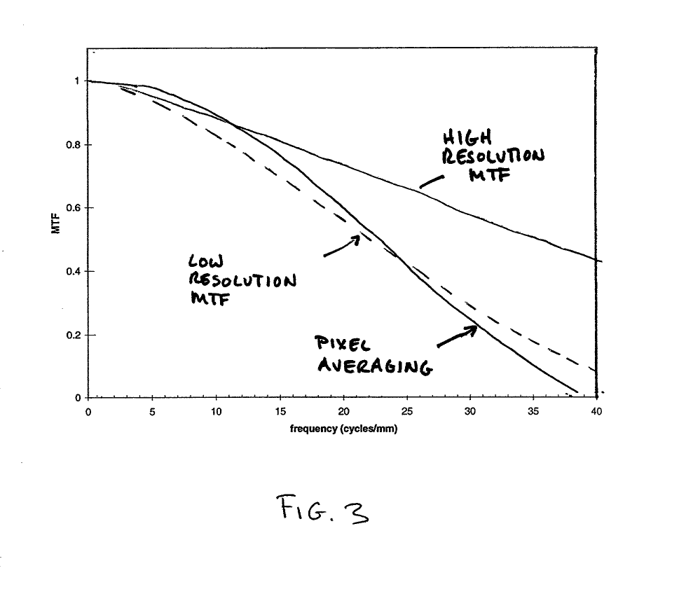

FIG. 3 presents the green MTF for a film scanner in two particular scanning modes. The MTF was obtained by using the detector MTF specifications cascaded with the lens specifications. For the lower resolution scanning mode, the scanner delivers image data pixels that are derived from high resolution image pixels, but averaged in a 2 pixel×2 pixel window. This is equivalent to applying a digital filter whose kernel coefficients are in a 2×2 array [.25 .25; .25 .25]. Hence, the effective high resolution mode scanner MTF was cascaded with the digital filter response, presented in FIG. 3, to yield the effective low resolution scanning MTF. This results in the MTF presented in the same FIG. 3. If we include this MTF response and a microdensitometer aperture area A_{microd} of 0.0018 mm² (corresponding to an aperture diameter of 48 μm) in equation 8 we obtain an α equal to, 1.55 for this green image record. This corresponds to a scanner effective aperture diameters of 38.5 μm.

FIG. 4 presents the green-record image noise statistics for the microdensitometer transformed for the image sampling characteristics of the scanner, for a particular film. Note that the noise standard deviation is increased due to a smaller aperture of the film scanner, compared to the aperture of the microdensitometer device.

In Block 22 of FIG. 2 the twice transformed image noise statistics (from Block 20) are again modified adding any image noise introduced by the second image capture device. Block 22 supplies these RMS noise statistics in the image metric and spatial sampling format of the images supplied by the second image capture device. In Block 22 the noise statistics from Block 20 are added to the RMS noise statistics of the image noise added by the image capture device 2 in quadrature,

σₜₒₜₐₗ=\sqrt{σ²_{scanner2}+σ²_{scanner noise}}. (1)

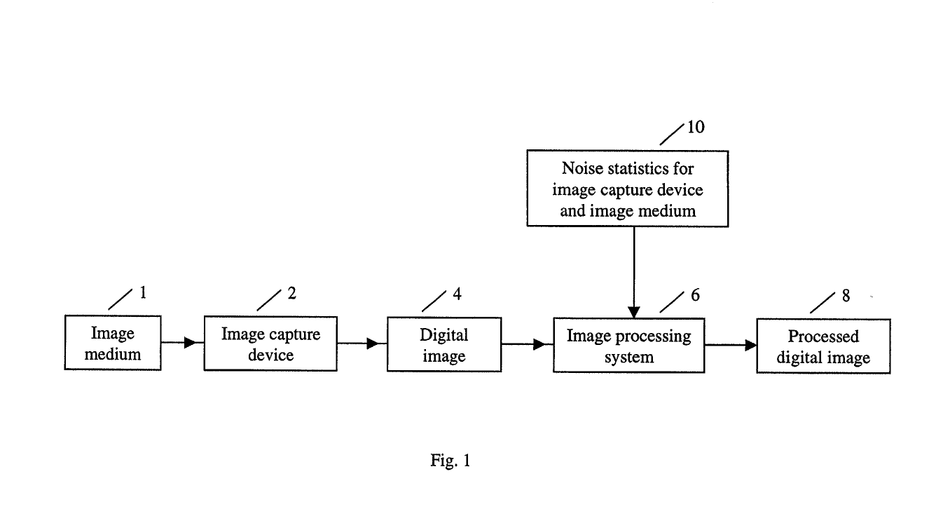

In Equation (11) σ_{scanner noise} is the RMS noise added by the second image capture device and σ_{scanner2} is supplied by Block 20. The result if Equation (11) in Block 28 is an image noise table including transformed noise statistics for the second image capture device and the image medium that is supplied to noise-sensitive image processing operations in Block 6 of FIGS. 1 and 2. The image processing system of Block 6 has algorithms which, in accordance with the present invention, can make use of the image noise table produced in Block 28. Such algorithm can include noise reduction, sharpening, tone scale enhancement, edge detection, or image compression.

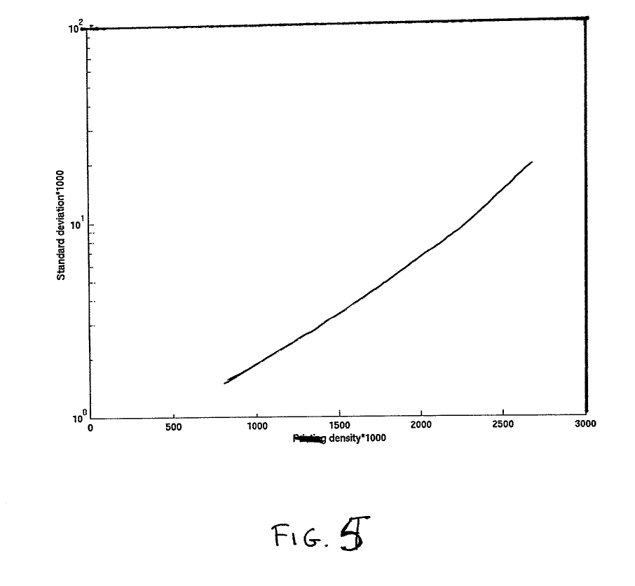

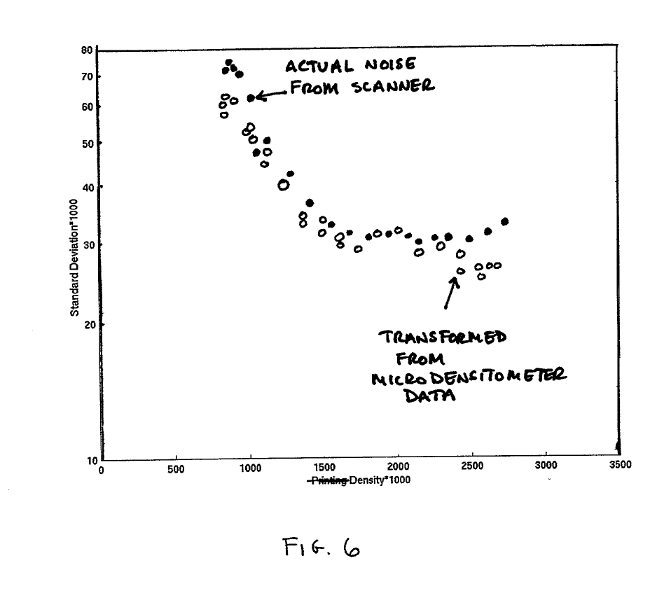

One embodiment would base σ_{scanner noise} on direct evaluation of the second image capture device. An alternative embodiment uses a parametric device noise model of data from a previous measurement of the image capture device, such as a 2-parameters model that incorporates the effects of dark noise and shot noise [P. D. Burns, Proc. SPIE, vol. 1071, pg. 144-152 (1989)]. FIG. 5 shows an example plot of scanner noise based on a two parameter (dark and shot noise) model, transformed to the image density metric. FIG. 6 shows a comparison of image noise statistics transformed from microdensitometer data with the inclusion of scanner noise, and that observed from the actual scanner.

A computer program product may include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for practicing a method according to the present invention.

The invention has been described with reference to a preferred embodiment. However, it will be appreciated that variations and modifications can be effected by a person of ordinary skill in the art without departing from the scope of the invention.

PARTS LIST

| | |
|---|---|
| 1 | image medium |
| 2 | image capture device |
| 4 | digital image |
| 6 | image processing system |
| 8 | processed digital image |
| 10 | noise statistics for image capture device and image medium |
| 12 | second image capture device |
| 14 | digital image from second image capture device |
| 16 | noise statistics, metric and spatial sampling characteristics from |
| | image capture device and image medium |
| 18 | metric noise transform |
| 20 | spatial sampling noise transform |
| 22 | addition of image noise statistics due to second imagecapture |
| | device |
| 24 | image metric for second image capture device |
| 26 | spatial sampling characteristics for second image capture device |
| 28 | image noise table |

What is claimed is:

1. A method for producing an image noise table having statistics in a particular metric format for use with image processing algorithms, comprising the steps of:
a) gathering estimated noise statistics of noise estimates provided from image capture medium, or image capture device(s), or combinations thereof which are in one or more metric formats;
b) transforming the gathered noise statistics from their metric format(s) to a second metric format useable in the image noise table;
c) transforming the second metric format noise statistics based upon the spatial qualities of image capture to a format for use in the image noise table; and
d) providing the image noise table using the transformed second metric format statistics.

2. The method of claim 1 wherein the image noise statistics are provided from a plurality of image capture devices.

3. The method of claim 1 where the gathered estimated noise statistics are provided by a manufacturer or produced by measuring parameters in the media or image capture device(s).

4. The method as described in claim 3 wherein the image capture device is a microdensitometer or a film scanner.

5. The method as set forth in claim 1 wherein the spatial qualities are produced by the steps of:
a) measuring the MTF's of an image capture device; and
b) using the Noise Power Spectrum of the image capture device and the measured MTF to produce the spatial quality of image noise statistics.

6. The method as described in claim 1 wherein the image processing algorithms include noise reduction, sharpening, tone scale enhancement, edge detection, or image compression.

7. A computer storage product having at least one computer storage medium having instructions stored therein causing one or more computers to perform the method of claim 1.
